(19) United States
(12) Patent Application Publication
(10) Pub. No.: US 2021/0100347 A1
(43) Pub. Date: Apr. 8, 2021

(54) TOOTHBRUSH COMPRISING BRISTLES HAVING DIFFERENT LENGTHS

(71) Applicants: Se In OH, Jeongeup-si (KR); Myung Hee PARK, Seoul (KR); Kwan Lak CHOI, Yongin-si (KR)

(72) Inventors: Se In OH, Jeongeup-si (KR); Myung Hee PARK, Seoul (KR); Kwan Lak CHOI, Yongin-si (KR)

(21) Appl. No.: 16/964,570

(22) PCT Filed: Jan. 21, 2019
(86) PCT No.: PCT/KR2019/000820

§ 371 Date: Dec. 22, 2020

(30) Foreign Application Priority Data
Jan. 25, 2018 (KR) 10-2018-0009148
Jan. 25, 2018 (KR) 10-2018-0009149
Mar. 22, 2018 (KR) 10-2018-0033540
Mar. 22, 2018 (KR) 10-2018-0033541
Jan. 17, 2019 (KR) 10-2019-0006222
Jan. 17, 2019 (KR) 10-2019-0006239

(51) Int. Cl. A46B 9/04; A46B 13/02; A61C 17/22

(52) U.S. Cl. CPC A46B 9/04; A46B 2200/1066; A61C 17/225; A46B 13/02

(57) ABSTRACT

The toothbrush comprises: a toothbrush handle; a supporting part connected to the toothbrush handle; and a toothbrush head having first bristles and second bristles which are formed on the supporting part. The second bristles are bristles placed inside the first bristles, the first bristles are outermost bristles, the length of the second bristles is 70% or less of the length of the first bristles, and, when the first bristles are inserted between the teeth from the inside of the teeth, at least one among the first bristles can pass the space between teeth and then protrude to the outside of the teeth.

### TECHNICAL FIELD

The present invention relates to a toothbrush including bristles having different lengths.

### BACKGROUND ART

Generally, the bristles of a toothbrush have the same or similar length. In this case, when brushing teeth, foreign material between the teeth may be removed to some degree, but foreign material caught tightly between the teeth is hardly removed. In other words, it is difficult to perfectly remove the foreign material.

Furthermore, since inside bristles of the toothbrush interfere with the movement of outside bristles, foreign material present in a space between the teeth and the gum may not be removed, so that there is a high possibility of gum disease.

As a result, dental floss should be separately used, and it is difficult to prevent teeth from decaying even if the teeth are brushed. Thus, due to tooth decay, people should frequently receive expensive dental treatment.

In addition, after brushing teeth, foreign material and toothpaste are often caught between the bristles. Even if the toothbrush is washed with water, it is difficult to remove the foreign material and the toothpaste. As a result, as time has passed, the toothbrush may be contaminated. Thus, as the contaminated toothbrush is used, the gum may be damaged.

### DISCLOSURE

### Technical Problem

Accordingly, the present invention has been made keeping in mind the above problems occurring in the related art, and is intended to provide a toothbrush including bristles having different lengths to eliminate the necessity of dental floss.

Another object of the present invention is to provide a toothbrush in which bristles having different lengths are alternately arranged to eliminate the necessity of dental floss.

### Technical Solution

In order to accomplish the above-described objects, the present invention provides a toothbrush including a toothbrush handle; a supporting part connected to the toothbrush handle; and a toothbrush head having first bristles and second bristles which are formed on the supporting part. The second bristles are bristles placed inside the first bristles, the first bristles are outermost bristles, the length of the second bristles is 70% or less of the length of the first bristles, and, when the first bristles are inserted between the teeth from the inside of the teeth, at least one of the first bristles passes the space between teeth and then protrudes to the outside of the teeth, the first bristle located on an end among the first bristles enters a back of a molar, a horizontal brushing operation causes the first bristles to be inserted between the teeth and the gum, thus removing foreign material between the teeth and the gum, and the first bristle surrounds a top, an inner surface, and an outer surface of the tooth at once.

The present invention provides a toothbrush head including a supporting part; and first bristles and second bristles formed on the supporting part. The second bristles are bristles placed inside the first bristles, the first bristles are outermost bristles, the length of the second bristles is 70% or less of the length of the first bristles, and, when the first bristles are inserted between the teeth from the inside of the teeth, at least one of the first bristles passes the space between teeth and then protrudes to the outside of the teeth, the first bristle located on an end among the first bristles enters a back of a molar, a horizontal brushing operation causes the first bristles to be inserted between the teeth and the gum, thus removing foreign material between the teeth and the gum, and the first bristle surrounds a top, an inner surface, and an outer surface of the tooth at once.

The present invention provides a toothbrush including a toothbrush handle; a supporting part connected to the toothbrush handle; and a toothbrush head having first bristles and second bristles which are formed on the supporting part. The first bristles and the second bristles are alternately arranged, the length of the second bristles is 70% or less of the length of the first bristles, and, when the first bristles are inserted between the teeth from the inside of the teeth, at least one of the first bristles passes the space between teeth and then protrudes to the outside of the teeth, the first bristle located on an end among the first bristles enters a back of a molar, at least one of the first bristles is bent at an angle of 70 degrees or more when brushing the teeth, and then hits foreign material between the teeth with a restoring force, thus removing the foreign material.

The present invention provides a toothbrush head including a supporting part; and first bristles and second bristles formed on the supporting part. The first bristles and the second bristles are alternately arranged, the length of the second bristles is 70% or less of the length of the first bristles, and, when the first bristles are inserted between the teeth from the inside of the teeth, at least one of the first bristles passes the space between teeth and then protrudes to the outside of the teeth, the first bristle located on an end among the first bristles enters a back of a molar, at least one of the first bristles is bent at an angle of 70 degrees or more when brushing the teeth, and then hits foreign material between the teeth with a restoring force, thus removing the foreign material.

The present invention provides a method of manufacturing a toothbrush including planting third bristles on a supporting part of a toothbrush head; cutting the planted third bristles to form second bristles; and planting first bristles into on the supporting part in a state where the second bristles are formed. Each of the second bristles has a length shorter than that of each of the first bristles.

### Advantageous Effects

The toothbrush according to the present invention is configured such that the length of the second bristle is 70% or less of the length of the first bristle, and consequently the first bristle may substantially perform a sweeping operation when brushing teeth. To be more specific, the first bristle is bent when brushing the teeth, and then the first bristle hits foreign material between the teeth or is inserted between the teeth to remove the foreign material using the bending force. Thus, when brushing the teeth, no foreign material remains in the teeth, so that it is possible to efficiently prevent the teeth from decaying.

Furthermore, since the length of the second bristle is short, the first bristle can easily remove foreign material between the teeth and the gum and thereby no foreign material remains between the teeth and the gum. Therefore, it is possible to prevent gum disease and to make the gum healthy.

In addition, since the length of the second bristles is short, it is possible to easily remove foreign material and toothpaste caught between the bristles after brushing the teeth. As a result, the contamination of the toothbrush can be minimized.

### DESCRIPTION OF DRAWINGS

FIG. 1 is a perspective view illustrating a toothbrush according to an embodiment of the present invention.

FIG. 2 is a plan view illustrating the toothbrush according to the embodiment of the present invention.

FIG. 3 is a diagram illustrating the shape of outermost bristles according to an embodiment of the present invention.

FIG. 4 is a diagram illustrating a structure (portion A) comparing an outermost bristle with an inner bristle according to an embodiment of the present invention.

FIGS. 5 and 6 are diagrams illustrating the process of removing foreign material using the toothbrush.

FIG. 7 is a diagram schematically illustrating the shape of a second bristle according to another embodiment of the present invention.

FIG. 8 is a diagram illustrating a toothbrush according to another embodiment of the present invention.

FIG. 9 is a diagram illustrating a toothbrush according to a further embodiment of the present invention.

FIG. 10 is a diagram illustrating a structure comparing an outermost bristle with an inner bristle according to an embodiment of the present invention.

FIG. 11 is a diagram illustrating a toothbrush according to another embodiment of the present invention.

FIG. 12 is a diagram illustrating a toothbrush according to another embodiment of the present invention.

FIG. 13 is a diagram illustrating a toothbrush according to another embodiment of the present invention.

FIG. 14 is a diagram illustrating the arrangement of bristles according to another embodiment of the present invention.

FIG. 15 is a diagram illustrating the function of the toothbrush according to the present invention.

FIG. 16 is a diagram illustrating a toothbrush according to another embodiment of the present invention.

FIG. 17 is a perspective view illustrating a toothbrush according to another embodiment of the present invention.

FIG. 18 is a sectional view illustrating a toothbrush according to an embodiment of the present invention.

FIG. 19 is a plan view illustrating a toothbrush according to an embodiment of the present invention.

FIG. 20 is a diagram illustrating a structure comparing a first bristle with a second bristle according to an embodiment of the present invention.

FIG. 21 is a diagram illustrating the process of removing foreign material using each of a conventional toothbrush and a toothbrush of the present invention.

FIG. 22 is a diagram illustrating a toothbrush according to another embodiment of the present invention.

FIG. 23 is a diagram illustrating a toothbrush according to another embodiment of the present invention.

FIG. 24 is a left side view or a right side view of the toothbrush of FIG. 23.

FIG. 25 is a diagram illustrating a toothbrush according to another embodiment of the present invention.

FIG. 26 is a left side view or a right side view of the toothbrush of FIG. 25.

FIG. 27 is a diagram illustrating a toothbrush according to another embodiment of the present invention.

FIG. 28 is a diagram illustrating a toothbrush according to another embodiment of the present invention.

FIG. 29 is a diagram illustrating a toothbrush according to another embodiment of the present invention.

FIG. 30 is a diagram illustrating a toothbrush according to another embodiment of the present invention.

FIG. 31 is a diagram illustrating a toothbrush according to another embodiment of the present invention.

FIGS. 32 to 41 are diagrams illustrating the structures of bristles according to other embodiments of the present invention.

### BEST MODE

In the present invention, the singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof. Furthermore, the term described in the specification, such as a “part” or a “module”, means a unit for processing at least one function or operation. This may be implemented as hardware or software, or be implemented as a combination of hardware and software.

The present invention is directed to a toothbrush that does not require dental floss and perfectly removes foreign material caught between the teeth, thus preventing gum disease.

A conventional toothbrush advertized as not requiring dental floss removes some of foreign material between the teeth, but still has a lot of foreign material between the teeth after brushing the teeth.

Furthermore, since bristles have the same length, the bristles may be interfered by surrounding bristles. Thus, the bristles may not perform a brushing operation, so that foreign material between the teeth and the gum may be hardly removed. As a result, foreign material is left between the teeth and the gum, thus causing gum disease and consequently making the gum weak.

In addition, even if the toothbrush is washed with water after brushing the teeth, foreign material and toothpaste entering between the bristles and accumulated on the bottom of a toothbrush head are hardly removed. As a result, the toothbrush itself is susceptible to contamination, so that the continuous use of the toothbrush may adversely affect the teeth and the gum.

On the other hand, the toothbrush of the present invention has bristles that may substantially perform the sweeping operation. Thus, foreign material between the teeth may be perfectly removed, which is found through an actual experiment. Particularly, the toothbrush may remove even foreign material that is firmly caught between the teeth. As a result, the dental floss is not required, and it is unnecessary to use a separate interdental toothbrush.

Furthermore, since the length of the inside bristles is considerably shorter than the length of the outermost bristles, the inside bristles do not interrupt the operation of the outermost bristles that remove foreign material between the teeth and the gum. As a result, the foreign material between the teeth and the gum may be efficiently removed using the outermost bristles, so that no foreign material remains between the teeth and the gum, thus preventing gum disease. Furthermore, since the outermost bristles may perform the sweeping operation, the gum may not be injured even if tooth-brushing is performed over the gum.

In addition, if the toothbrush itself is washed after brushing the teeth, the length of some bristles is considerably short, thus perfectly removing foreign material and toothpaste present between the bristles, and preventing the contamination of the toothbrush itself.

Hereinafter, various embodiments of the present invention will be described in detail with reference to the accompanying drawings.

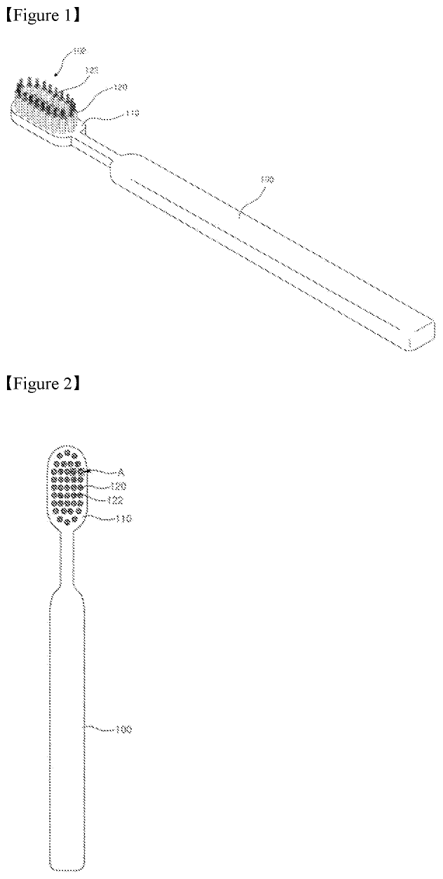

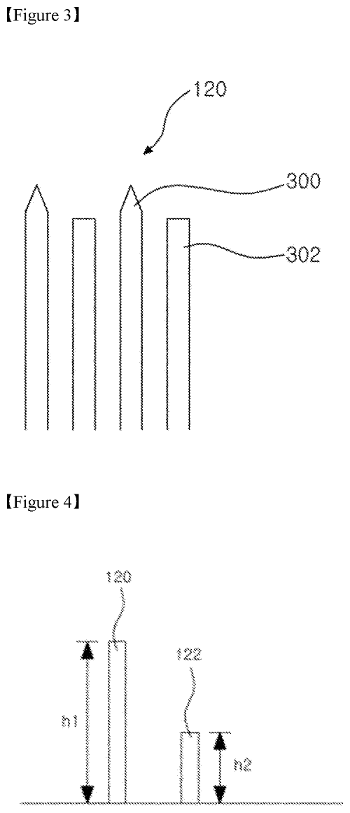

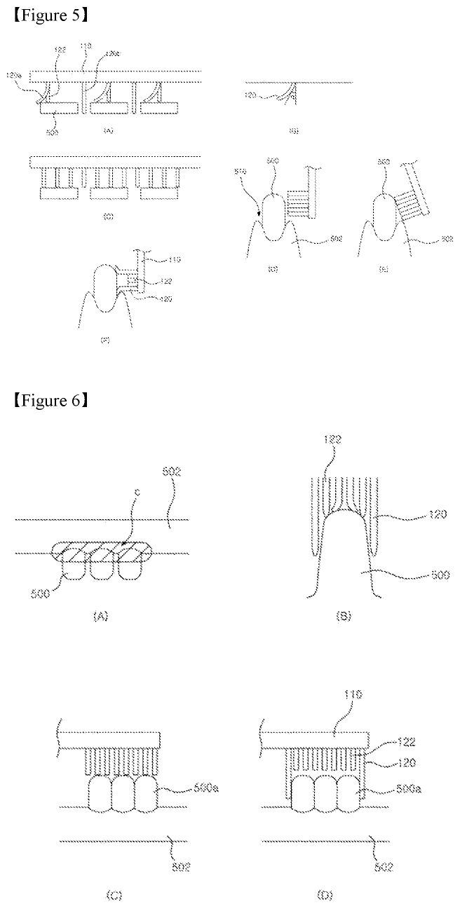

FIG. 1 is a perspective view illustrating a toothbrush according to an embodiment of the present invention, FIG. 2 is a plan view illustrating the toothbrush according to the embodiment of the present invention, and FIG. 3 is a diagram illustrating the shape of outermost bristles according to an embodiment of the present invention. FIG. 4 is a diagram illustrating a structure (portion A) comparing an outermost bristle with an inner bristle according to an embodiment of the present invention, and FIGS. 5 and 6 are diagrams illustrating the process of removing foreign material using the toothbrush. FIG. 15 is a diagram illustrating the function of the toothbrush according to the present invention.

Referring to FIGS. 1 and 2, the toothbrush of this embodiment includes a toothbrush handle 100 and a toothbrush head 102. The shape of the toothbrush handle 100 may be changed in various ways without being limited to that of FIG. 1, and may adopt an existing toothbrush handle.

The toothbrush head 102 includes a supporting part 110, first bristles 120, and second bristles 122.

The first bristles 120 may each have an elliptical shape, for example, and be installed in the supporting part 110. For example, the first bristles 120 may be inserted into holes of the supporting part 110 to be secured thereto.

According to an embodiment, the first bristles 120 are outermost bristles, and may be equal or similar in length to bristles of a general toothbrush.

The second bristles 122 are bristles located inside the first bristles 120, and may be shorter in length than the bristles of the general toothbrush.

In other words, in the toothbrush of the present invention, the second bristles 122 that are the inside bristles may be shorter in length than the first bristles 120 located at an outermost position. The reason why the length of the second bristles 122 is smaller than the length of the first bristles 120 is because the first bristles 120 located at the outermost position while brushing the teeth may perform the sweeping operation with a large restoring force.

According to an embodiment, the length h2 of the second bristles 122 may be about 70% or less of the length h1 of the first bristles 120, preferably 50% or less, and optimally 42% or less.

When the length h2 of the second bristles 122 is more than 70% of the length h1 of the first bristles 120, it is difficult to sufficiently remove foreign material between the teeth even if the first bristles 120 perform the sweeping operation during tooth-brushing. The reason is because the first bristles 120 may not hit foreign material between the teeth with a sufficient restoring force (elastic force) and the first bristles 120 are not properly inserted into a space between the teeth.

Of course, a case where the length h2 of the second bristles 122 is about 70% to 50% of the length h1 of the first bristles 120 may be less effective to sweep or penetrate between the teeth or between the teeth and the gum compared with a case where the length h2 of the second bristles 122 is about 50% or less of the length h1 of the first bristles 120, but is more effective and can sufficiently remove foreign material compared with a case where the length h2 of the second bristles 122 is more than 70% of the length h1 of the first bristles 120.

If the length h2 of the second bristles 122 is more than 70% of the length h1 of the first bristles 120, the effect of the first bristle 120 for brushing the teeth or penetrating between the teeth or between the teeth and the gum may be substantially slight. In other words, the toothbrush in which the bristles have the same length or a slight difference in length is not operated to substantially perform a sweeping operation. As a result, foreign material between the teeth may not be sufficiently removed. Particularly, it is impossible to remove foreign material that is tightly caught between the teeth.

On the other hand, when the length h2 of the second bristles 122 is 70% or less of the length h1 of the first bristles 120, and preferably 50% or less, the first bristles 120 are sufficiently sweep and brush the teeth during tooth-brushing, and consequently foreign material between the teeth may be perfectly removed. To be more specific, in a state where the second bristles 122 are not in contact with the tooth surface during tooth-brushing, the long first bristles 120 sweep the teeth. As a result, the bent first bristles 120 hit foreign material between the teeth with a large restoring force, so that the foreign material between the teeth can be sufficiently removed.

Furthermore, since the length of the second bristle 122 is considerably shorter than the length of the first bristle 120, the second bristle 122 may pass through the teeth when the second bristle 122 is inserted from the inside of the teeth to the outside thereof, as shown in FIG. 15(A). As a result, the second bristle 122 may function as the dental floss, so that it is unnecessary to use separate dental floss or interdental toothbrush.

The operation of the toothbrush will be described in detail after the structure of the toothbrush is further described.

Referring to FIG. 2, the first bristle 120 and the second bristle 122 may have the same width, but the present invention is not limited thereto.

In order to maximize the sweeping effect of the first bristle 120, the first bristle 120 may be formed of soft hairs or microfiber hairs, while the second bristle 122 may be formed of hairs stronger than the first bristle 120. In other words, the strength of the second bristle 122 may be higher than that of the first bristle 120.

Furthermore, in order to maximize the sweeping effect, the first bristle 120 may be a double bristle structure including first hairs 300 each having a triangular shape and second hairs 302 each having a shorter length than the first hairs 300, as shown in FIG. 3.

According to an embodiment, the second bristle 122 may have a length which is about 42% or less of the length of the first hair 300 of the first bristle 120, and have a length which is about 50% or less of the length of the second hair 302. For example, the first hair 300 may be 1.2 cm, the second hair 302 may be 1 cm, and the second bristle 120 may be 0.5 cm.

The entire arrangement of the bristles is as follows. As shown in FIG. 2, up to five or more bristles may be arranged in the widthwise direction of the toothbrush head 102. In the case of a general toothbrush, four bristles are arranged vertically. The reason why one or more bristles are further arranged compared with an existing toothbrush is as follows: if the space of the second bristles 122 is increased, the sweeping effect of the first bristles 120 is further increased and it is easy to remove foreign material between the teeth and the gum.

Meanwhile, only the length of the outermost first bristles 122 is formed to be long, but the length of bristles just inside the outermost bristles may also be formed to be long. In this case, the sweeping effect is present but is considerably reduced, so that the effect of removing foreign material between the teeth may be deteriorated.

Furthermore, the bristles may be implemented such that the outside bristles are short and the inside bristles are long. However, as the sweeping area of the bristles is reduced, the effect of removing foreign material is deteriorated and the efficiency of removing foreign material between the teeth and the gum is reduced, compared with a structure in which the outermost bristles are long.

When considered as a whole, the length of the inner second bristles 122 is implemented to be 50% or less of the length of the first bristles 120 located at the outermost position while up to five or more bristles are arranged in the widthwise direction of the toothbrush head 102. Such a structure is efficient to remove foreign material between the teeth.

According to another embodiment, the second bristles located at the inside position may have the length of about 70% or less of the first bristles located at the outermost position, and third bristles as well as the first bristles may be arranged at an outer position, especially the outermost position. Here, the third bristles may be arranged alternately with the first bristles while having the length of 70% or less, and preferably 50% or less of the first bristles and having the shape of a circle, an ellipse, or a square. In other words, the first and third bristles having different lengths may be alternately arranged at the outermost position. In this case, the sweeping effect of the first bristles may be further increased. Meanwhile, the third bristle may have the same length as the second bristle, and the third and second bristles may have different lengths.

In summary, in the toothbrush of this embodiment, short bristles may be arranged inside or outside long bristles. In order to provide the sweeping effect, the length of the short bristle may be about 70% or less of the length of the long bristle.

In another aspect, in order to maximize the sweeping effect, bristles adjacent to long bristles may have a short length. For example, at least one, preferably all of neighboring bristles in four directions on the basis of the long bristles may have a short length. In other words, the structure of the bristles may be changed in various ways as long as the bristle adjacent to the long bristles has the length of about 70% or less of the long bristle.

In a further aspect, short bristles are not arranged between long bristles and an empty space may be present. In other words, the empty space may replace the short bristles. As a result, the sweeping effect may be maximized. This will be described below in detail.

Hereinafter, the operation of the toothbrush when brushing the teeth will be described with reference to FIGS. 5, 6, and 15.

In the case of using the conventional toothbrush, the bristles are moved when brushing the teeth, as shown in FIG. 5(C). In other words, due to the inside bristles, the bristles hardly sweep the teeth or are hardly inserted into a space between the teeth. As a result, the toothbrush may not efficiently remove the foreign material between the teeth. Particularly, the toothbrush may hardly remove foreign material that is tightly caught between the teeth. When considered as a whole, the conventional toothbrush may simply brush only a plane, so that it is unsuitable for brushing the teeth that are complex and have severe uneven portions.

Furthermore, the bristles of the conventional toothbrush are not inserted into a space 510 between the teeth and the gum as shown in FIGS. 5 (D) and (E). As a result, the conventional toothbrush may not substantially brush portions between the teeth and the gum.

On the other hand, in the case of the toothbrush of the present invention, as shown in FIG. 5(A), the first bristles 120 are bent to sweep the teeth 500.

To be more specific, the first bristle 120a which is bent during tooth-brushing hits foreign material between the teeth with a large restoring force as the toothbrush moves, or the first bristle 120b is inserted into the space between the teeth. As a result, the foreign material between the teeth is splashed to the outside of the teeth to be removed or is pushed inwards to be removed. In other words, the toothbrush of the present invention is suitable for brushing the teeth that are complex and have severe uneven portions.

According to an embodiment, since the length of the second bristle 122 is considerably shorter than that of the first bristle 120, the first bristle 120 is bent as shown in FIG. 5(B), and may be bent at the angle α of particularly 30 degrees or more, for example, 70 degrees or more. In other words, at least one of the first bristles 120 is bent at 70 degrees or more when brushing the teeth. Consequently, as the toothbrush moves, the first bristles 120 hits foreign material between the teeth with the bending force (restoring force) or penetrates between the teeth. This is impossible in conventional toothbrushes having bristles having the same or similar length.

Furthermore, since the middle portion of the toothbrush is recessed, a horizontal brushing operation causes the second bristles 122 to penetrate between the teeth 500 and the gum 502 while the second bristles are flared as shown in FIG. 5(F) and FIG. 15(B). As a result, foreign material caught between the teeth 500 and the gum 502 may be removed, thus preventing gum disease. A dentist does not recommend people to brush teeth in the horizontal direction, because this causes a tooth surface to be worn out when brushing the teeth in the horizontal direction using the conventional toothbrush. However, since the toothbrush of the present invention is configured such that the short second bristle 122 does not come into contact with the tooth surface, i.e. only the long first bristle 120 comes into contact with the tooth surface, the tooth surface is hardly worn out even if the teeth are brushed in the horizontal direction. Therefore, it is possible to brush the teeth in the horizontal direction.

Furthermore, even if the first bristle 120 is in direct contact with a gum region C, the first bristle 120 massages while sweeping the gum during tooth-brushing, thus preventing the gum from being injured. In other words, the toothbrush of the present invention can brush the teeth while massaging the gum. On the other hand, since the conventional toothbrush is configured such that the bristles are not bent when coming into contact with the gum, it is apt to injure the gum.

Furthermore, since the length of the first bristles 120 located at the outermost position is long, it is easy to remove foreign material near the gum 502 in a small space among spaces between the teeth.

The brushing operation will be described by dividing it into horizontal and vertical brushing operations. In the case of the horizontal brushing operation, the first bristles 120 penetrate between the teeth and the gum 502, so that the effect of removing foreign material between the teeth and the gum 502 is excellent. In both the horizontal and vertical brushing operations, the long first bristles 120 penetrate between the teeth and hit the foreign material between the teeth, so that the effect of removing the foreign material between the teeth is excellent.

According to an embodiment, since the second bristle 122 is considerably shorter than the first bristle 120, the second bristle 122 may pass between the teeth when inserting the second bristle 122 between the teeth from the inside of the teeth as shown in FIG. 15(A). In other words, the second bristle 122 functions as the dental floss. Consequently, even if the dental floss or the interdental toothbrush is not separately used, foreign material between the teeth can be easily and reliably removed. Furthermore, the scaling effect can be achieved with only the tooth-brushing operation.

Meanwhile, the second bristle 122 arranged in the middle portion is considerably shorter in length than the first bristle 120, so that a structure recessed in the middle portion is formed. Thus, the first bristles 120 may surround the teeth 500 as shown in FIG. 6(B). As a result, three surfaces (the tops, inner surfaces, and outer surfaces of the teeth) of the teeth 500 may be brushed at once. This is impossible in the conventional toothbrush.

Furthermore, if the toothbrush is pushed towards a molar 500a in a three-surface brushing state, as shown in FIG. 6(D) and FIG. 15(C), a first bristle located in an end among the first bristles 120 may enter the rear side (inside) of the molar 500a, so that it is possible to brush the rear side of the molar 500a. Thus, it is possible to brush even a wisdom tooth. Of course, the toothbrush of the present invention may brush the rear side of the molar 500a as well as the periphery of the molar 500a. On the other hand, the conventional toothbrush may not brush three surfaces of the tooth, and the bristle may not enter the rear side of the molar even if the toothbrush is put toward the molar, so that it is impossible to brush the rear side of the molar.

In summary, the toothbrush of the present invention may perform the horizontal brushing, the vertical brushing, the three-surface brushing, the molar brushing, and the function of the dental floss. In other words, the toothbrush is an all-in-one toothbrush capable of performing various functions.

Generally, the tooth decay occurs because foreign material is not removed properly. In the case of using the conventional toothbrush, the foreign material remains in the teeth and the toothbrush itself acts as a contamination source, so that there is a high probability of causing the tooth decay. Thus, even if the teeth are frequently brushed, the tooth decay often occurs, so that expensive dental treatment is required. Consequently, the cost of dental treatment may be increased.

On the other hand, since the toothbrush of the present invention almost perfectly eliminates foreign material, the probability of the tooth decay may be dramatically reduced. In other words, the tooth decay may be prevented only by the tooth-brushing operation, so that the number of dental treatments is reduced and cost caused by the dental treatment is considerably reduced.

Meanwhile, although not mentioned above, the toothbrush head and the toothbrush handle may be separated from each other. Thus, it is possible to use the toothbrush by replacing only the toothbrush head with a new one when necessary.

The process of washing the toothbrush will be described. Since the length of the second bristle 122 inside the first bristle 120 is short, it is possible to easily remove foreign material and toothpaste with water, even if the foreign material and the toothpaste are present on the second bristles 122 after brushing the teeth. In other words, the toothbrush may be managed in a sanitary way even if the toothbrush is used.

On the other hand, the conventional toothbrush has a lot of foreign material and toothpaste between the bristles even if the toothbrush is washed, and the foreign material and the toothpaste are not easily removed. As a result, this is considerably insanitary and causes the gum to be damaged.

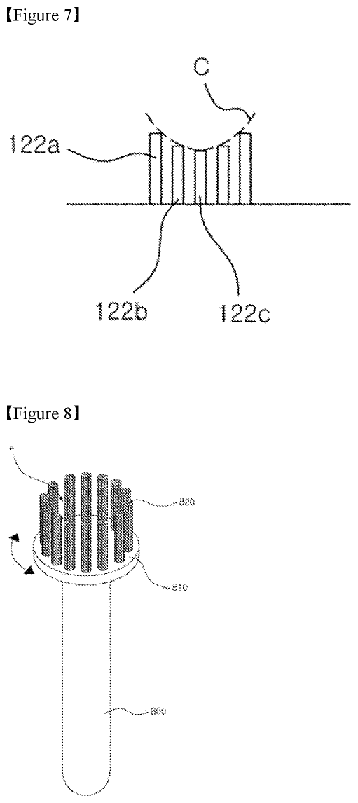

FIG. 7 is a diagram schematically illustrating the shape of a second bristle according to another embodiment of the present invention.

Referring to FIG. 7, the second bristles 122a, 122b and 122c each having the length of about 70% or less of the first bristle may have different lengths. For example, the second bristles 122a, 122b and 122c may be arranged to form a curve C.

According to an embodiment, the curvature of the curve C may be equal or similar to the curvature of the teeth. As a result, the second bristles may further come into close contact with the teeth to surround the teeth when brushing the teeth.

Preferably, the length of the second bristle 122a having the largest length among the second bristles 122a, 122b, and 122c is 70% or less of the length of the first bristle.

FIG. 8 is a diagram illustrating a toothbrush according to another embodiment of the present invention.

Referring to FIG. 8, the toothbrush of this embodiment includes a toothbrush handle 800, a supporting part 810, and bristles 820.

According to an embodiment, the toothbrush may be an electric toothbrush, and be configured such that the supporting part 810 and the toothbrush handle 800 are separated from each other.

For example, an internal threaded part may be formed on the upper end of the toothbrush handle 800, and an external threaded part may be formed on a portion of the supporting part 810, so that the toothbrush handle 800 and the supporting part 810 may be separated from each other. Of course, the supporting part 810 may be rotated by a motor.

As another example, the supporting part 810 may be rotatably coupled to the toothbrush handle 800 not in a motorized method but manually. Various technologies are present as such a coupling method, and any technology may be applied.

As shown in FIG. 8, the bristles 820 may be arranged while having the shape of a circle, an ellipse, or a square. Here, the bristles 820 may correspond to the outermost bristles of a common electric toothbrush.

According to an embodiment, unlike the common electric toothbrush configured such that other bristles are present inside the outermost bristles, the toothbrush of this embodiment has no bristle in a space e inside the bristles 820. The reason is as follows: since the supporting part 810 is rotated as shown in FIG. 8 when brushing the teeth, good brushing is possible even if there are no bristles therein.

As in the previous embodiments, in the toothbrush in which the supporting part 810 rotates, the bristles 820 sweep the teeth. Particularly, since the bristles 820 are considerably bent, hit foreign material between the teeth with a bending force, or are inserted between the teeth to push the foreign material, the foreign material between the teeth may be perfectly removed.

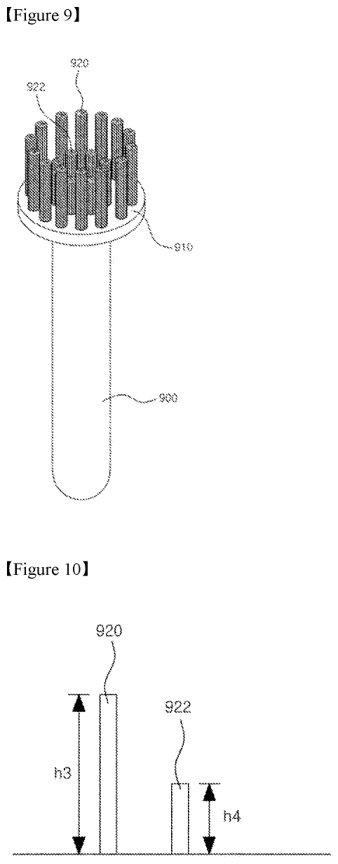

FIG. 9 is a diagram illustrating a toothbrush according to a further embodiment of the present invention, and FIG. 10 is a diagram illustrating a structure comparing an outermost bristle with an inner bristle according to an embodiment of the present invention.

Referring to FIG. 9, the toothbrush of this embodiment is an electric toothbrush, for example, and includes a toothbrush handle 900, a supporting part 910, first bristles 920, and second bristles 922.

The first bristles 920 are the outermost bristles, while the second bristles 922 are bristles inside the first bristles 920.

As shown in FIG. 10, the length h4 of the second bristles 922 may be 70% or less, and preferably 50% of the length h3 of the first bristle 920.

Since the operation and effect of the toothbrush are the same as those of the above embodiments, a description thereof will be omitted.

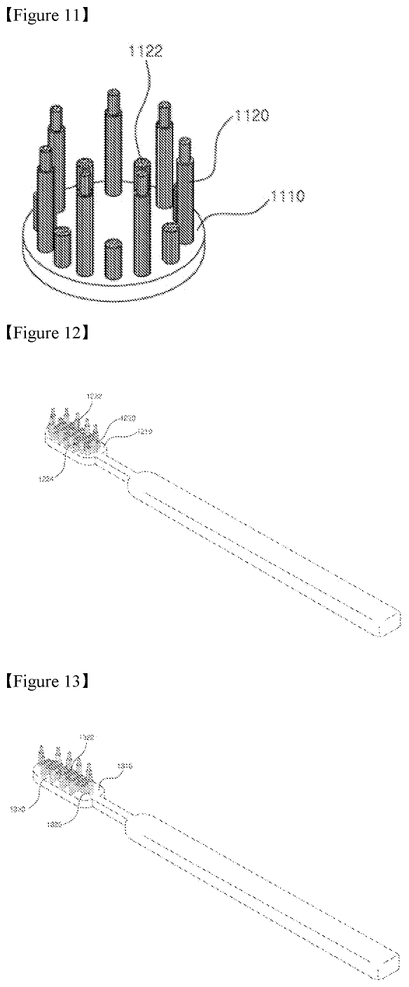

FIG. 11 is a diagram illustrating a toothbrush according to another embodiment of the present invention. Here, the toothbrush handle is omitted.

Referring to FIG. 11, the toothbrush of this embodiment includes a supporting part 1110, first bristles 1120, and second bristles 1122.

The first bristles 1120 are long bristles, and are arranged on an outer portion of the supporting part 1110. Here, no bristle may be present in a space inside the first bristles 1120.

The first bristles 1120 may be arranged while having the shape of a circle or an ellipse, for example, and the second bristles 1122 having short length may be arranged between the first bristles 1120. Here, the second bristle 1122 may have the length of 70% or less, and preferably 50% or less of the first bristle 1120.

According to an embodiment, the first bristles 1120 and the second bristles 1122 may be alternately arranged.

According to another embodiment, two first bristles and one second bristle may be alternately arranged. In other words, as long as the first bristles of long length and the second bristles of short length are alternately arranged, the arrangement of the bristles may be changed in various ways.

FIG. 12 is a diagram illustrating a toothbrush according to another embodiment of the present invention.

Referring to FIG. 12, the toothbrush of this embodiment may include a toothbrush handle, a supporting part 1210, first bristles 1220, second bristles 1222, and third bristles 1224.

The first bristles 1220 may be arranged while having the shape of a circle or an ellipse, and may have long length.

The second bristles 1222 maybe arranged inside the first bristles 1220, and may have the length of about 70% or less, for example, 50% or less of the first bristle 1220.

The third bristles 1224 may be arranged alternately with the first bristles 1220 while having the shape of a circle or an ellipse, and may have the length of about 70% or less of the first bristle 1220.

In other words, the second bristles 1222 of short length may be arranged inside the first bristles 1220 of long length, and the long first bristles 1220 and the short third bristles 1224 may be alternately arranged while having the shape of a circle or an ellipse.

FIG. 13 is a diagram illustrating a toothbrush according to another embodiment of the present invention.

Referring to FIG. 13, the toothbrush of this embodiment may include a toothbrush handle, a supporting part 1310, first bristles 1320, and second bristles 1322.

The first bristles 1320 may be arranged while having the shape of a circle or an ellipse, and may have long length.

The second bristles 1322 may be arranged inside the first bristles 1320, and may have the length of about 70% or less, for example, 50% or less of the first bristle 1320.

Unlike FIG. 12 in which the first bristles and the short third bristles are alternately arranged, in this embodiment, an empty space may be formed instead of the third bristle, i.e. the first bristles 1320 and the empty spaces may be alternately arranged. Meanwhile, the second bristle 1322 may be present on a longitudinal imaginary line corresponding to the empty space.

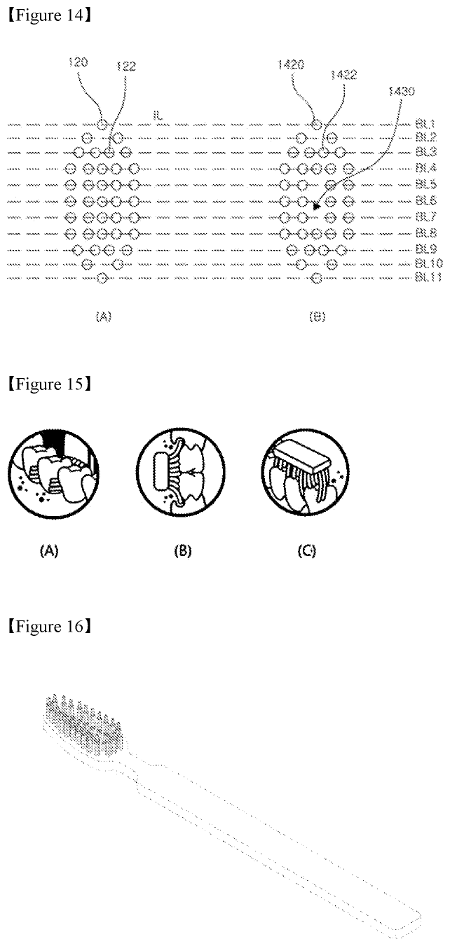

FIG. 14 is a diagram illustrating the arrangement of bristles according to another embodiment of the present invention.

FIG. 14(A) is the structure of FIG. 1, and short second bristles 122 may be present inside long first bristles 120.

Referring to FIG. 14(B), short second bristles 1422 may be present inside long first bristles 1420, and an empty space 1430 may be present inside the second bristles 1422.

When seen in a widthwise imaginary line, for example, when seen in BL5 and BL6, the long first bristle 1420, the short second bristle 1422, and the empty space may be present together.

Although the circular toothbrush head has been described above, the toothbrush head may have the structure of a different width, e.g. the shape of a snake head, as shown in FIG. 16. In other words, the structure of the toothbrush head may be changed in various ways. The bristle structure of FIGS. 1 to 14 may be applied to the head.

In summary, long first bristles, short second bristles, and empty spaces are appropriately arranged, so that the first bristle may substantially sweep the teeth and penetrate between the teeth or between the teeth and the gum to remove foreign material when brushing the teeth.

Now, a process will be described. It is difficult to directly plant short second bristles into holes of the supporting part. Thus, a method of manufacturing the toothbrush of the present invention may include the steps of planting long bristles into holes of a supporting part corresponding to second bristles, cutting the planted bristles to form the second bristles, and planting the first bristles into corresponding holes in a state where the second bristles are formed. In other words, in order to form the second bristles, a cutting process may be used in a state where the long bristles are planted.

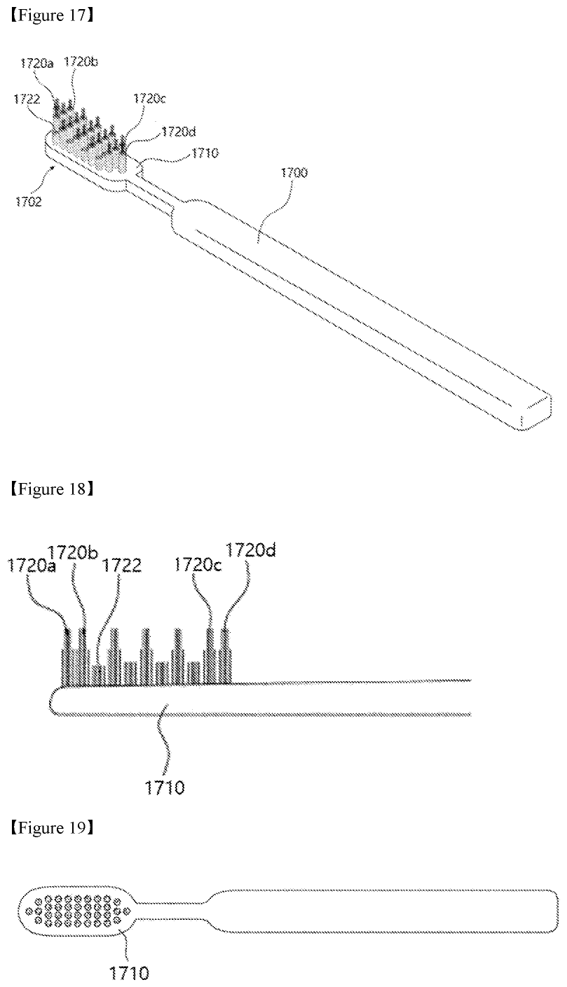

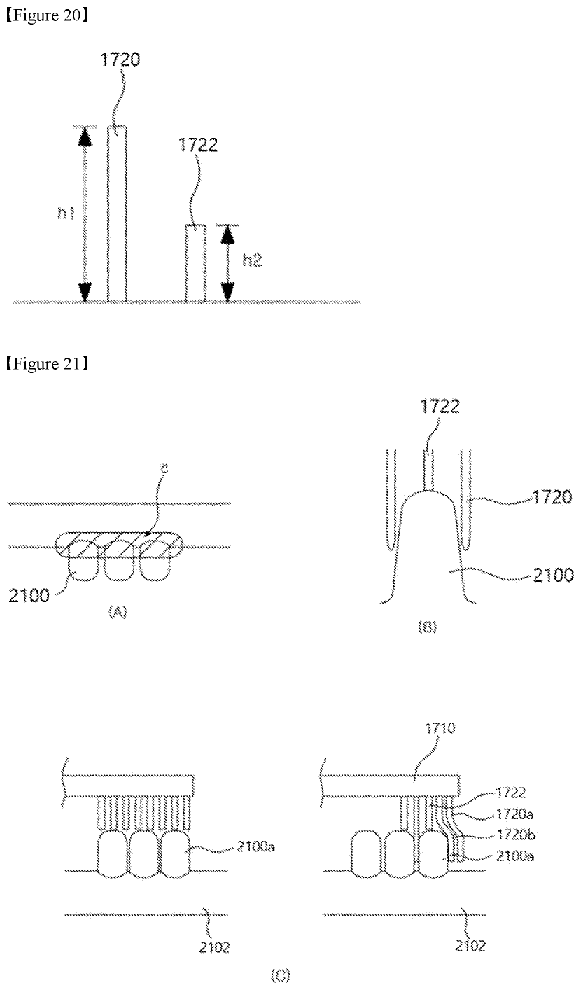

FIG. 17 is a perspective view illustrating a toothbrush according to another embodiment of the present invention, FIG. 18 is a sectional view illustrating a toothbrush according to an embodiment of the present invention, and FIG. 19 is a plan view illustrating a toothbrush according to an embodiment of the present invention. FIG. 20 is a diagram illustrating a structure comparing a first bristle with a second bristle according to an embodiment of the present invention, and FIG. 21 is a diagram illustrating the process of removing foreign material using each of a conventional toothbrush and a toothbrush of the present invention.

Referring to FIGS. 17 to 19, the toothbrush of this embodiment includes a toothbrush handle 1700 and a toothbrush head 1702. The shape of the toothbrush handle 1700 may be changed in various ways without being limited to the structure of FIG. 17, and may adopt the conventional toothbrush handle.

The toothbrush head 1702 includes a supporting part 1710, first bristles 1720a, 1720b, 1720c and 1720d, and second bristles 1722.

The first bristles 1720 are bristles having relatively long length, and may be installed in the supporting part 1710. For example, the first bristles 1720 may be fixedly inserted into holes of the supporting part 1710.

The first bristles 1720a and 1720d are bristles located at ends in a longitudinal direction of the toothbrush head 1702, and the first bristles 1720b and 1720c are first bristles other than the end first bristles 1720a and 1720d. The first bristles 1720a, 1720b, 1720c, and 1720d may be equal or similar in length to the bristle of the common toothbrush.

According to an embodiment, the outermost first bristles 1720a and 1720d may have long length, and the following bristles 1720b and 1720c may have short lengths. However, in this case, only one first bristle 1720a or 1720d is present, so that it may be difficult to maintain strength when performing the function of the dental floss. Thus, all of the end first bristles 1720a and 1720d and the following bristles 1720b and 1720c should have long length to realize an efficient brushing operation. In this case, it is possible to brush the teeth with sufficient strength. If the number of each of the end first bristles 1720a and 1720d is three or more, the following bristle may have short length. Of course, in consideration of brushing the molar, each of the end first bristles 1720a and 1720d is preferably two or less to make it easy to insert the toothbrush towards the molar.

As shown in FIGS. 17 and 18, the second bristles 1722 may be arranged alternately with the first bristles 1720b, and may be shorter in length than the bristle of the common toothbrush. As a result, the long first bristles 1720 and the short second bristles 1722 may be alternately arranged.

In other words, in the toothbrush of the present invention, the second bristles 1722 may be shorter in length than the first bristles 1720. The reason why the second bristles 1722 are formed to be shorter in length than the first bristles 1720 is because the first bristles 1720 may sweep and brush the teeth with a sufficient restoring force (elastic force).

According to an embodiment, the length h2 of the second bristle 1722 may be about 70% or less of the length h1 of the first bristle 1720, preferably 50% or less, and optimally 42% or less.

Since the effect obtained when the length h2 of the second bristle 1722 is more than 70% of the length h1 of the first bristle 120 and the effect obtained when the length of the second bristle is 70% or less of the length of the first bristle have been described in the above embodiments, the effects will not be described below.

The operation of the toothbrush will be described in detail after the structure of the toothbrush is further described.

Referring to FIG. 19, the first bristle 1720 and the second bristle 1722 may have the same width, but the present invention is not limited thereto.

The strength of the second bristle 1722 may be higher than the strength of the first bristle 1720.

Furthermore, in order to maximize the sweeping effect, the first bristle 1720 may be a double bristle structure including first hairs 300 each having a triangular shape and second hairs 302 each having a shorter length than the first hairs 300, as shown in FIG. 3.

According to an embodiment, the second bristle 1722 may have a length which is about 42% or less of the length of the first hair 300 of the first bristle 1720, and have a length which is about 50% or less of the length of the second hair 302. For example, the first hair 300 may be 1.2 cm, the second hair 302 may be 1 cm, and the second bristle 1722 may be 0.5 cm.

In summary, the length of the second bristle 1722 may be 70% or less of the length of the first bristle 1720, and preferably 50% or less. This is effective to remove foreign material between the teeth and to remove foreign material between the teeth and the gum.

In another aspect, in order to maximize the sweeping effect, bristles adjacent to long bristles may have a short length. For example, at least one, preferably all of neighboring bristles in four directions on the basis of the long bristles may have a short length. In other words, the structure of the bristles may be changed in various ways as long as the bristle adjacent to the long bristles has the length of about 70% or less of the long bristle.

In a further aspect, short bristles are not arranged between long bristles and an empty space may be present. In other words, the empty space may replace the short bristles. As a result, the sweeping effect may be maximized.

For example, as will be described later, the second bristle 1722 may be replaced with an empty space, and some short bristles or empty spaces may be arranged between the first bristles 1720.

Hereinafter, the operation of the toothbrush during tooth-brushing will be described with reference to FIGS. 21 and 15.

The general operation and effect of the toothbrush according to the present invention remain the same as those described in the embodiment of FIGS. 1 to 6. However, the structure of FIG. 21 where the bristle brushes three surfaces and penetrates between the teeth is slightly different from the structure of the embodiment shown in FIGS. 1 to 6 where the bristle brushes three surfaces and penetrates between the teeth.

When comparing the bristle structure of FIG. 1 which is recessed in the middle portion thereof with the bristle structure of FIG. 17 in which the bristles are alternately arranged, the toothbrush of FIG. 1 is more effective to remove foreign material between the teeth and the gum, and the toothbrush of FIG. 17 is more effective to remove foreign material between the teeth. Of course, both the toothbrush of FIG. 1 and the toothbrush of FIG. 17 have the function of removing foreign material between the teeth and the gum, the function of removing foreign material between the teeth, the function of brushing the back of the molar, the function of the dental floss, the function of the interdental toothbrush, and the function of massaging the gum. In other words, both the toothbrush of FIG. 1 and the toothbrush of FIG. 17 are all-in-one toothbrushes. Furthermore, the toothbrushes of the present invention are configured to minimize the brushing of the tooth surface and thoroughly brush all portions around the teeth. In other words, the toothbrushes of the present invention may realize all brushing functions recommended by dentists. Furthermore, the toothbrushes of the present invention are much more sanitary than the conventional toothbrush.

In the morning, there is less foreign material between the teeth, so that it is easy to brush the teeth. Thus, it is efficient to use the toothbrush of FIG. 1 having the excellent gum massaging effect. In the evening, since a lot of foreign material is accumulated between the teeth and the foreign material such as meat is caught between the teeth, it is efficient to use the toothbrush of FIG. 17 which is effective to remove foreign material between the teeth. In other words, if the toothbrushes of the present invention are selectively used depending on a condition where foreign material is accumulated around the teeth, it is possible to more efficiently manage the teeth.

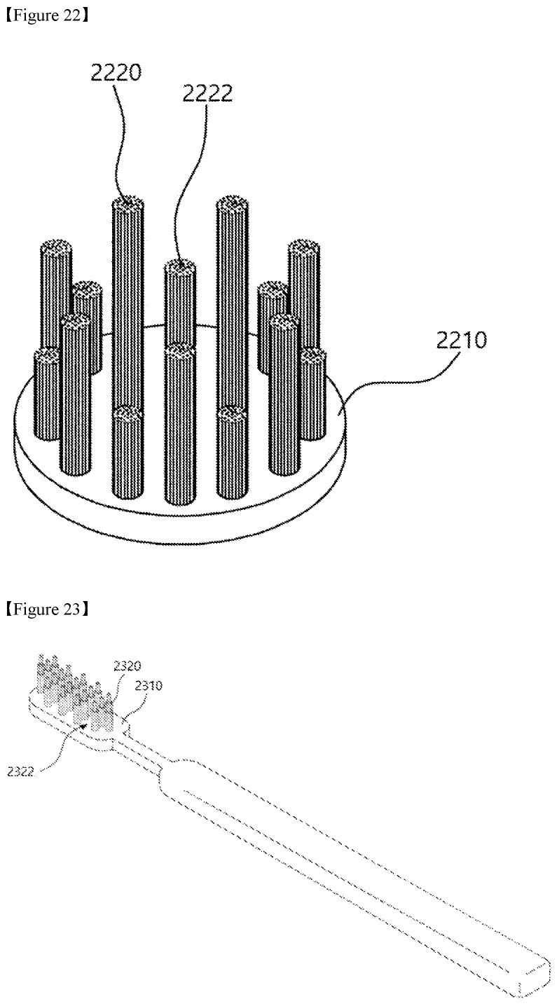

FIG. 22 is a diagram illustrating a toothbrush according to another embodiment of the present invention.

Referring to FIG. 8, the toothbrush of this embodiment includes a toothbrush handle (not shown), a supporting part 2210, first bristles 2220, and second bristles 2222.

According to an embodiment, the toothbrush may be an electric toothbrush, and be configured such that the supporting part 2210 and the toothbrush handle are separable from each other.

For example, an internal threaded part may be formed on the upper end of the toothbrush handle, and an external threaded part may be formed on a portion of the supporting part 2210, so that the toothbrush handle and the supporting part 2210 may be separated from each other. Of course, the supporting part 2210 may be rotated by a motor.

As another example, the supporting part 2210 may be rotatably coupled to the toothbrush handle not in a motorized method but manually. Various technologies are present as such a coupling method, and any technology may be applied.

As shown in FIG. 22, the bristles 2220 and 2222 may be arranged while having the shape of a circle, an ellipse, or a square. Here, the bristles 2220 may correspond to the outermost bristles of a common electric toothbrush.

According to an embodiment, unlike the common electric toothbrush configured such that other bristles are present inside the outermost bristles, the toothbrush of this embodiment has no bristle in a space e inside the bristles 2220 and 2222. The reason is as follows: since the supporting part 2210 is rotated as shown in FIG. 22 when brushing the teeth, good brushing is possible even if there are no bristles therein.

According to another embodiment, the second bristle 2222 may have the length which is 70% or less of the length of the first bristle 2220, and preferably 50% or less.

In this case, when the supporting part 2210 rotates, the first bristles 2220 sweep the teeth. Particularly, since the first bristles 2220 are considerably bent, hit foreign material between the teeth with a bending force, or are inserted between the teeth to push the foreign material, the foreign material between the teeth may be perfectly removed. In this case, the second bristles 2222 may not interfere with the sweeping operation of the first bristles 2220.

According to another embodiment, the first bristles 2220 and the second bristles 2222 may be arranged at the outermost position, and third bristles may be arranged inside the first and second bristles. The third bristle may have length which is 70% or less of the length of the first bristle 2220.

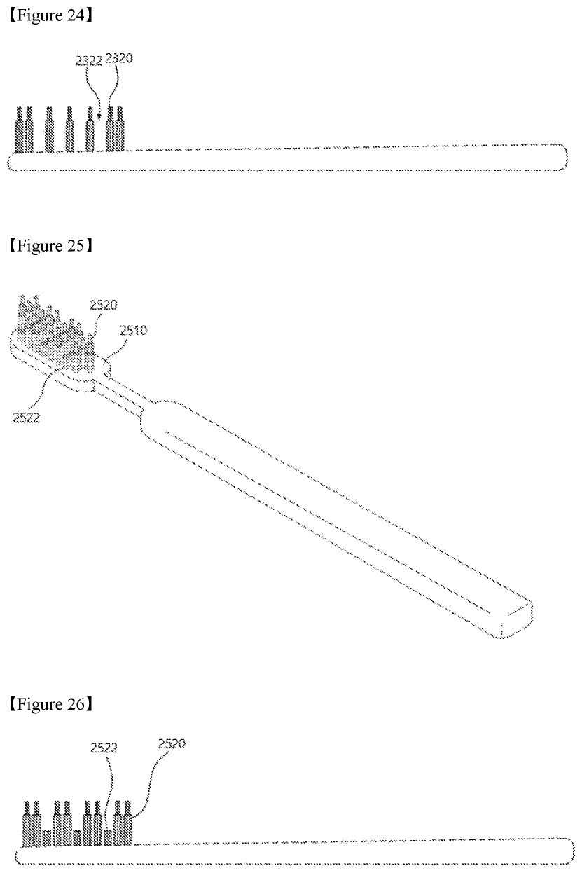

FIG. 23 is a diagram illustrating a toothbrush according to another embodiment of the present invention, and FIG. 24 is a left side view or a right side view of the toothbrush of FIG. 23.

Referring to FIG. 23, the toothbrush of this embodiment may include a toothbrush handle, a supporting part 2310, and bristles 2320.

As compared with the embodiment of FIG. 17, an empty space 2322 is present instead of the second bristle 2322. In other words, the bristles 2320 and the empty space 2322 may be alternately arranged.

According to an embodiment, due to the empty space 2322, a distance between two-line bristles at the outermost position in the longitudinal direction of the toothbrush head may be different from a distance between inner bristles, as shown in FIG. 24.

FIG. 25 is a diagram illustrating a toothbrush according to another embodiment of the present invention, and FIG. 26 is a left side view or a right side view of the toothbrush of FIG. 25.

Referring to FIG. 25, the toothbrush of this embodiment may include a toothbrush handle, a supporting part 2510, first bristles 2520, and second bristles 2522.

The second bristles 2522 each have a length which is 70% or less of the length of the first bristle 2520, and are arranged alternately with the first bristles 2520.

To be more specific, as shown in FIG. 26, two first bristles 2520 and one second bristle 2522 may be alternately arranged in the longitudinal direction of the toothbrush head.

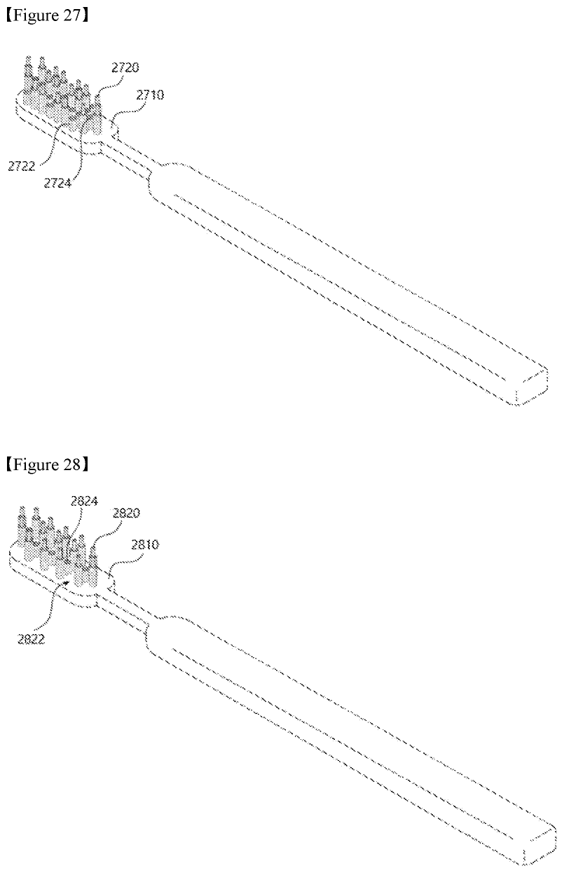

FIG. 27 is a diagram illustrating a toothbrush according to another embodiment of the present invention.

Referring to FIG. 27, the toothbrush of this embodiment includes a toothbrush handle, a supporting part 2710, first bristles 2720, second bristles 2722, and third bristles 2724.

The second bristles 2722 each may have a length which is 70% or less of the length of the first bristle 2720, and be arranged alternately with the first bristles 2720 in the longitudinal direction of the toothbrush head. Here, one first bristle 2720 and one second bristle 2722 may be alternately arranged, or two first bristles 2720 and one second bristle 2722 may be alternately arranged.

The third bristles 2724 each may have a length which is 70% or less of the length of the first bristle 2720, and be arranged between the first bristles 2720 in the widthwise direction (transverse direction) of the toothbrush head.

FIG. 28 is a diagram illustrating a toothbrush according to another embodiment of the present invention.

Referring to FIG. 28, the toothbrush of this embodiment includes a toothbrush handle, a supporting part 2810, first bristles 2820, and third bristles 2824.

As compared with the embodiment of FIG. 27, the second bristle 2732 of FIG. 27 is replaced with the empty space 2822. In other words, the first bristle 2820 and the empty space 2822 may be alternately arranged in the longitudinal direction of the toothbrush head.

The third bristles 2824 each may have a length which is 70% or less of the length of the first bristle 2820, and be arranged between the first bristles 2820 in the widthwise direction (transverse direction) of the toothbrush head.

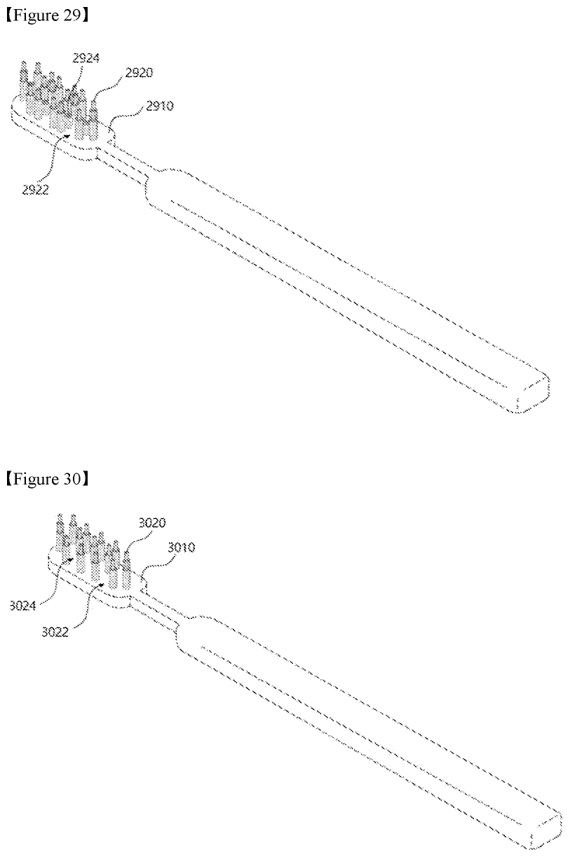

FIG. 29 is a diagram illustrating a toothbrush according to another embodiment of the present invention.

Referring to FIG. 29, the toothbrush of this embodiment includes a toothbrush handle, a supporting part 2910, first bristles 2920, and third bristles 2924.

Two first bristles 2920 and an empty space 2922 are alternately arranged in the longitudinal direction of the toothbrush head.

The third bristle 2924 may have a length which is 70% or less of the length of the first bristle 2920, and be arranged between the first bristles 2920 in the widthwise direction (transverse direction) of the toothbrush head.

FIG. 30 is a diagram illustrating a toothbrush according to another embodiment of the present invention.

Referring to FIG. 30, the toothbrush of this embodiment includes a toothbrush handle, a supporting part 3010, and first bristles 3020.

One first bristle 3020 and an empty space 3022 are alternately arranged in the longitudinal direction of the toothbrush head.

An empty space 3024 may be present between the first bristles 3020 in the widthwise direction of the toothbrush head.

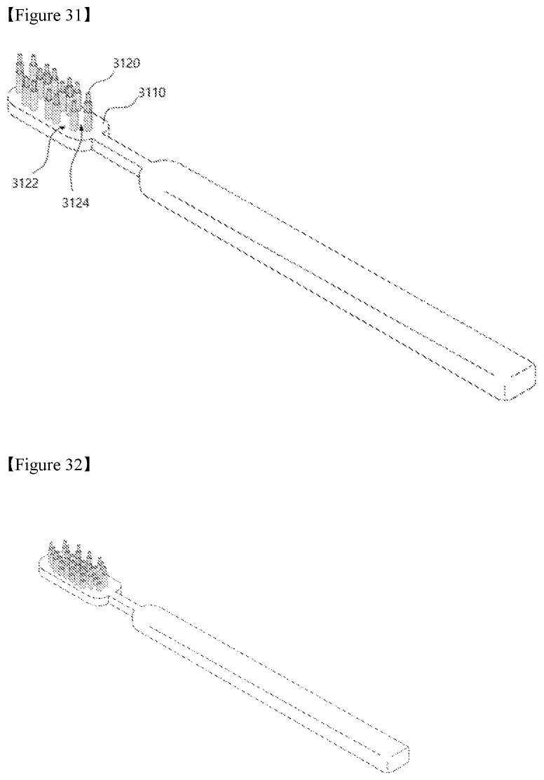

FIG. 31 is a diagram illustrating a toothbrush according to another embodiment of the present invention.

Referring to FIG. 31, the toothbrush of this embodiment includes a toothbrush handle, a supporting part 3110, and first bristles 3120.

Two first bristles 3120 and an empty space 3122 are alternately arranged in the longitudinal direction of the toothbrush head.

An empty space 3124 may be present between the first bristles 3120 in the widthwise direction of the toothbrush head.

In summary, long bristles and short bristles may be alternately arranged in the longitudinal direction of the toothbrush head or long bristles and empty spaces may be alternately arranged, and the short bristles or the empty spaces may be present between the long bristles in the widthwise direction of the toothbrush head. As a result, the long bristle may sweep or penetrate into the space between the teeth and the gum or the space between the teeth, thus removing foreign material. Here, the short bristle may have the length which is 70% or less of the long bristle.

Referring to the process, it is difficult to directly plant short bristles into holes of the supporting part. Thus, the method of manufacturing the toothbrush of the present invention may include the steps of planting the long bristles into the holes of the supporting part corresponding to the bristles, cutting the planted bristles to form the short bristles, and planting the long bristles into the corresponding holes in a state where the short bristles are formed. In other words, in order to form the short bristles, the cutting process may be used in a state where the long bristles are planted.

FIGS. 32 to 41 are diagrams illustrating the structures of bristles according to other embodiments of the present invention.

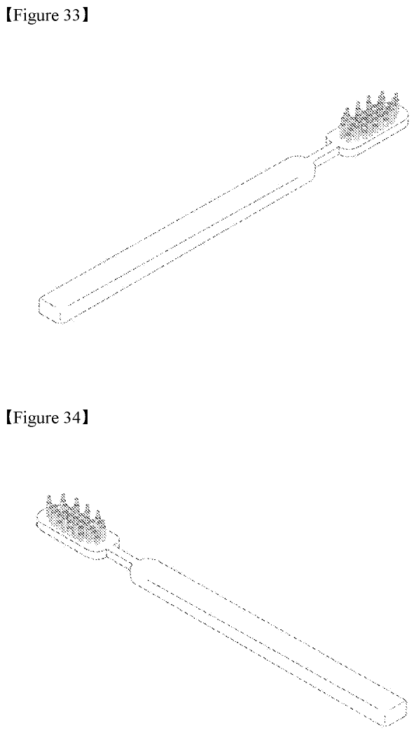

Referring to FIGS. 32 and 33, short bristles may be diagonally arranged.

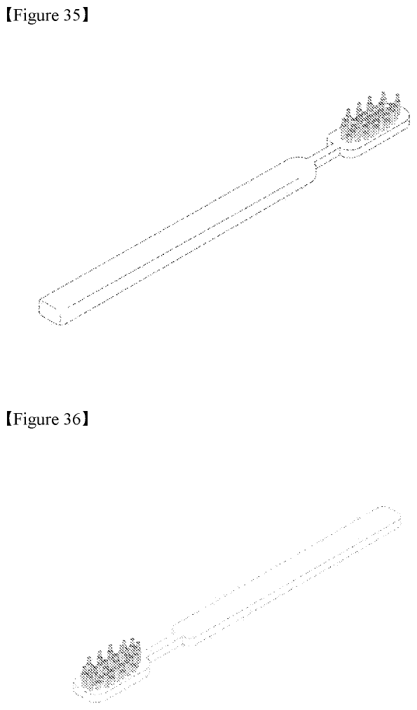

Referring to FIGS. 34 and 35, short bristles may be diagonally arranged, and the short bristles may be arranged between long bristles.

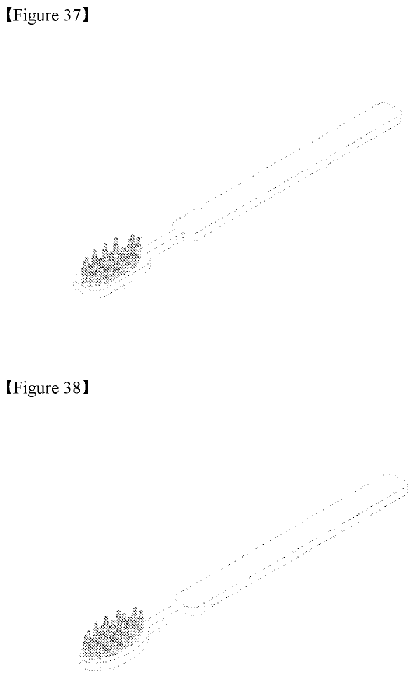

Referring to FIGS. 36 and 37, short bristles may be arranged in a ‘V’ or ‘inverted V’ shape.

Referring to FIG. 38, the number of bristles is smaller than that of the bristles of FIG. 17, and long bristles and short bristles are alternately arranged. Only one row of long bristles may be arranged on one end.

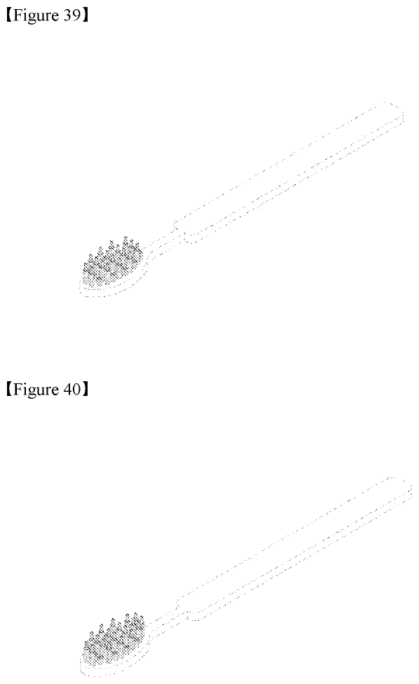

Referring to FIG. 39, the number of bristles is smaller than that of the bristles of FIG. 17, and long bristles and short bristles are alternately arranged. The short bristles instead of the long bristles may be arranged on one end. However, long bristles should be arranged on the other end to brush the inside of the molar.

Referring to FIG. 40, the number of bristles is smaller than that of the bristles of FIG. 17, and long bristles and short bristles are alternately arranged. Two rows of long bristles may be arranged on an end adjacent to the toothbrush handle.

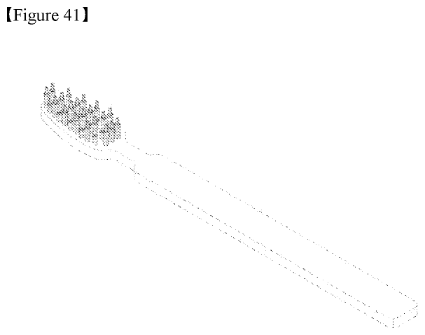

Referring to FIG. 41, the toothbrush head may have a structure of a varying width, for example, the shape of a snake head, unlike the above embodiments having a circular shape. In other words, the structure of the toothbrush head may be changed in various ways. The bristle structures of FIGS. 17 to 41 may be applied to the head.

Although not shown in the drawings, a groove may be formed in the longitudinal direction from the end surface of the toothbrush handle, and fragrance material (e.g. solid) may be filled in the groove. An open portion of the groove may be sealed after the fragrance material is filled during the manufacture of the toothbrush handle. Furthermore, a fine-sized hole may be formed between the groove and the surface of the toothbrush handle. As a result, this may give a nice smell while a user brushes his or her teeth. This fragrance effect can provide the most pleasant brushing effect in combination with the toothbrush structure of the above embodiments for achieving refreshing effect.

Although the foregoing description is merely for illustrative purposes, it is apparent to those skilled in the art that the present invention may be changed and modified in various ways without departing from the scope of the present invention, which is described in the following claims.

1. A toothbrush comprising:
a toothbrush handle;
a supporting part connected to the toothbrush handle; and
a toothbrush head having first bristles and second bristles which are formed on the supporting part,
wherein the second bristles are bristles placed inside the first bristles, the first bristles are outermost bristles, the length of the second bristles is 70% or less of the length of the first bristles, and, when the first bristles are inserted between the teeth from the inside of the teeth, at least one of the first bristles passes the space between teeth and then protrudes to the outside of the teeth, the first bristle located on an end among the first bristles enters a back of a molar, a horizontal brushing operation causes the first bristles to be inserted between the teeth and the gum, thus removing foreign material between the teeth and the gum, and the first bristle surrounds a top, an inner surface, and an outer surface of the tooth at once.

2. The toothbrush of claim 1, wherein only bristles each having a length which is 50% or less of the length of the first bristle are arranged in four directions from at least one of the first bristles.

3. The toothbrush of claim 1, wherein the first bristle comprises a double bristle structure including a first hair and a second hair having a length shorter than that of the first hair,
the second bristle has a length which is 42% or less of the length of the first hair, and 50% or less of the length of the second hair, and
at least one of the first bristles is bent at an angle of 70 degrees or more when brushing the teeth, and then hits foreign material between the teeth with a bending force or is inserted between the teeth, thus removing the foreign material.

4. The toothbrush of claim 1, further comprising:
at least one third bristle having a length which is 70% or less of the length of the first bristle,
wherein the first bristles and the third bristle are alternately arranged while forming the shape of a circle, ellipse, or square, and the second bristles are arranged inside the first bristles and the third bristle.

5. The toothbrush of claim 1, wherein an empty space is present between the first bristles, the second bristles are arranged on a longitudinal imaginary line corresponding to the empty space, and the first bristles and the empty space are alternately arranged.

6. The toothbrush of claim 1, wherein a groove is formed from an end surface of the toothbrush handle in a longitudinal direction thereof, and a fine-sized hole is formed between the groove and a surface of the toothbrush handle, and
fragrance material is filled in the groove, and an open portion of the groove is sealed after the fragrance material is filled in the groove during the manufacture of the toothbrush handle.

7. (canceled)

8. A toothbrush comprising:
a toothbrush handle;
a supporting part connected to the toothbrush handle; and
a toothbrush head having first bristles and second bristles which are formed on the supporting part,
wherein the first bristles and the second bristles are alternately arranged, the length of the second bristles is 70% or less of the length of the first bristles, and, when the first bristles are inserted between the teeth from the inside of the teeth, at least one of the first bristles passes the space between teeth and then protrudes to the outside of the teeth, the first bristle located on an end among the first bristles enters a back of a molar, at least one of the first bristles is bent at an angle of 70 degrees or more when brushing the teeth, and then hits foreign material between the teeth with a restoring force, thus removing the foreign material.

9. The toothbrush of claim 8, wherein only bristles each having a length which is 50% or less of the length of the first bristle are arranged in four directions from at least one of the first bristles.

10. The toothbrush of claim 8, wherein two-line bristles at the outermost position in the longitudinal direction of the toothbrush head comprises first bristles having long length, and the first bristles and the second bristles are alternately arranged from the inner second bristles.

11. The toothbrush of claim 8, wherein an empty space or a third bristle having a length which is 70% or less of that of the first bristle is present between the first bristles in a widthwise direction of the toothbrush head.

12. A toothbrush head comprising:
a supporting part; and
first bristles and second bristles formed on the supporting part,
wherein the first bristles and the second bristles are alternately arranged, the length of the second bristles is 70% or less of the length of the first bristles, and, when the first bristles are inserted between the teeth from the inside of the teeth, at least one of the first bristles passes the space between teeth and then protrudes to the outside of the teeth, the first bristle located on an end among the first bristles enters a back of a molar, at least one of the first bristles is bent at an angle of 70 degrees or more when brushing the teeth, and then hits foreign material between the teeth with a restoring force, thus removing the foreign material.

13. (canceled)
